(19) United States
(12) Patent Application Publication
(10) Pub. No.: US 2026/0161057 A1
(43) Pub. Date: Jun. 11, 2026

(54) AUXILIARY SHOOTING STRUCTURE

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 19/048,677

(22) Filed: Feb. 7, 2025

(30) Foreign Application Priority Data
Dec. 9, 2024 (CN) 2024230345753

(51) Int. Cl. G03B 17/56

(52) U.S. Cl. CPC G03B 17/561; G03B 17/563

(57) ABSTRACT

The present application discloses an auxiliary shooting structure, which includes a handheld component, a stabilizer mounting component, and a power supply component. The handheld component features an accommodation cavity designed to house an electrical connecting line. The stabilizer mounting component is mounted on the handheld component and electrically connected to the electrical connecting line, facilitating the attachment of a shooting device. The power supply component is positioned on either the handheld component, the stabilizer mounting component, or both, and can establish an electrical connection with the gimbal and/or the electrical connecting line.

### CROSS-REFERENCE TO RELATED APPLICATIONS

The present application for patent claims priority to and the benefit of pending Chinese Application No. 2024230345753, filed Dec. 9, 2024, and hereby expressly incorporated by reference herein as if fully set forth below in its entirety and for all applicable purposes.

### TECHNICAL FIELD

The present disclosure pertains to the technical realm of photographic accessories, specifically to an auxiliary shooting structure.

### INTRODUCTION

In videography and photography tasks, numerous shooting tools are often utilized. For instance, a photographer may use a three-axis stabilizer to assist in capturing videos. Typically, when employing such a stabilizer, it is necessary to control the shooting device through auxiliary handheld and other external equipment. However, existing auxiliary handheld structures exhibit a relatively unreasonable distribution of components, and their functionality is relatively limited.

### BRIEF SUMMARY

The primary objective of the present invention is to provide an auxiliary shooting structure that enhances multifunctionality during handheld shooting operations.

This paper presents an auxiliary shooting structure, including:
A handheld component, featuring an accommodation cavity designed to house an electrical connecting line;
a stabilizer mounting component mounted on the handheld component and electrically connected to the electrical connecting line, facilitating the attachment of a shooting device; and
a power supply component positioned on the handheld component or/and the stabilizer mounting component; and wherein the power supply component can establish an electrical connection with the gimbal and/or the electrical connecting line.

### Beneficial Effects

The shooting structure disclosed herein can accommodate various photographic accessories via the handheld component. In addition to fulfilling shooting requirements, it also includes a power supply component that can power the handheld component, thereby enabling power supply to external devices and fulfilling diverse needs.

### BRIEF DESCRIPTION OF THE DRAWINGS

To elucidate the technical solutions presented in the embodiments of the present application or the prior art, the accompanying drawings necessary for describing these embodiments or the prior art will be briefly introduced below. It is apparent that the accompanying drawings described herein represent merely some embodiments of the present application. For those skilled in the art, without the necessity for inventive effort, other drawings can be derived based on the structures depicted in these drawings.

FIG. 1 is a diagram illustrating an auxiliary shooting structure according to some aspects of the disclosure.

FIG. 2 is a diagram illustrating an exploded view of the auxiliary shooting structure according to some aspects of the disclosure.

FIG. 3 is a diagram illustrating a folded state of the auxiliary shooting structure according to some aspects of the disclosure.

FIG. 4 is a diagram illustrating a connecting base according to some aspects of the disclosure.

FIG. 5 is a diagram illustrating a partial cross-sectional view of the auxiliary shooting structure according to some aspects of the disclosure.

FIG. 6 is a diagram illustrating an enlarged view of section A in FIG. 5.

FIG. 7 is a diagram illustrating a cross-sectional view of a tripod.

### REFERENCE NUMERALS OF ELEMENTS IN THE DRAWINGS

10, auxiliary shooting structure;
1, handheld component; 11, accommodation cavity; 12, first ring pipe; 121, first pipe; 122, second pipe; 123, first alloy sleeve; 124, first disk; 125, first threaded connection bayonet; 13, second ring pipe; 131, third pipe; 132, fourth pipe; 133, second alloy sleeve; 134, second disk; 135, second threaded connection bayonet; 14, first handle part; 141, third threaded connection bayonet; 142, fourth threaded connection bayonet; 15, second handle part; 16, electrical port; 161, mounting member; 162, circuit board; 163, contact pin; 17, first connecting segment; 18, second connecting segment; 19, electrical connecting line;
2, stabilizer mounting component; 21, connecting base;
3, power supply component; 31, power supply interface; 32, battery mounting bracket;
4, output port;
5, first unlocking ring;
6, second unlocking ring;
7, tripod; 71, foot support part; 711, button; 712, limiting part; 72, connecting part; 721, limiting hole;
8, docking handle;
9, power supply line.

The objectives, functional characteristics, and advantages of the present invention will be further elucidated with reference to the embodiments and accompanying drawings.

### DETAILED DESCRIPTION

The subsequent passages provide a precise and exhaustive portrayal of the technical solutions embodied within this application, drawing upon the illustrative figures. It is to be understood that the enumerated embodiments constitute but a fraction of the broader scope and are not exhaustive. Consequently, any alternative embodiments derived by ordinary technicians in the relevant field, without the necessity for inventive ingenuity, are encompassed within the protective ambit of this application.

In the present disclosure, directional terminology (e.g., up, down, left, right, front, rear, etc.) serves exclusively to elucidate the relative positional arrangements and dynamic states among components within a specific orientational framework as depicted in the drawings. In the event of a change in this orientational framework, the directional designations will naturally align with the new configuration.

Furthermore, the utilization of ordinal indicators such as “first,” “second,” and so forth, in this application, is purely for descriptive clarity and cannot be misconstrued as signifying relative significance or implicitly indicating the number of technical features referenced. As such, expressions constrained by such ordinal designations may encompass one or more of the indicated features, either explicitly or implicitly. Moreover, the phrase “and/or” used throughout this document encompasses three distinct possibilities: Taking A and B as examples, it embraces the technical solution exclusive to A, the technical solution exclusive to B, as well as the technical solution that concurrently satisfies both A and B. Additionally, the integration of technical solutions across distinct examples is permissible, albeit contingent upon the feasibility of such integration by ordinary technicians in the field. In instances where the combined technical solutions conflict or are unfeasible, such integrations are deemed non-existent and thereby excluded from the scope of protection afforded by this application.

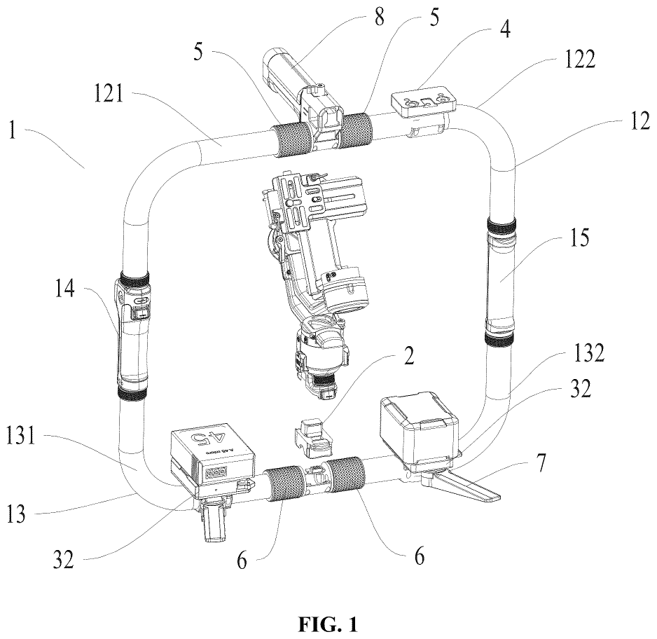

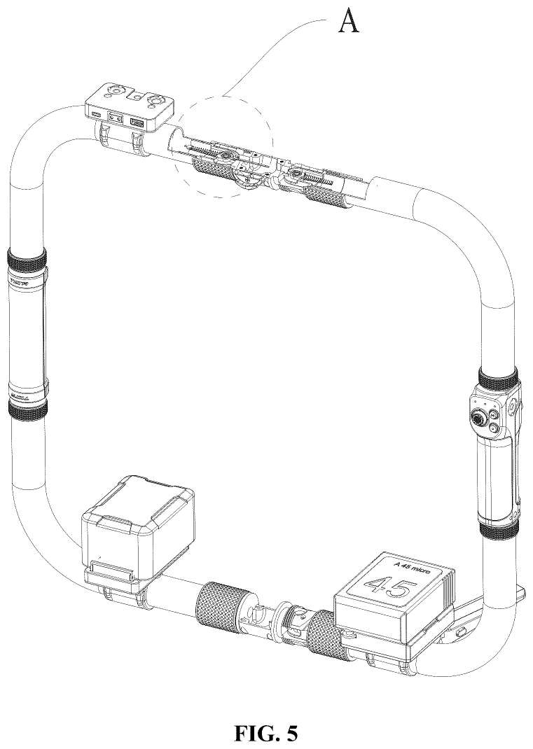

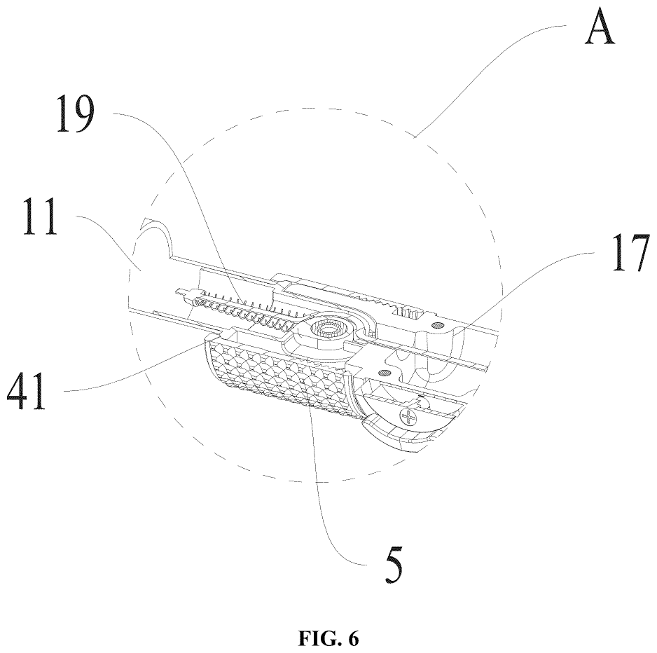

Referring to FIGS. 1-2 and FIGS. 5-6, the present application discloses an auxiliary shooting structure 10, which includes a handheld component 1, featuring an accommodation cavity 11 designed to house an electrical connecting line 19, a stabilizer mounting component 2 mounted on the handheld component 1 and electrically connected to the electrical connecting line 19, facilitating the attachment of a shooting device. The power supply component 3 is positioned on either the handheld component 1, the stabilizer mounting component 2, or both, and can establish an electrical connection with the stabilizer mounting component 2 and/or the electrical connecting line 19.

The presented shooting structure, while satisfying shooting requirements, is capable of powering the handheld component 1 through the power supply component 3, thereby providing power to external devices and catering to a variety of usage needs.

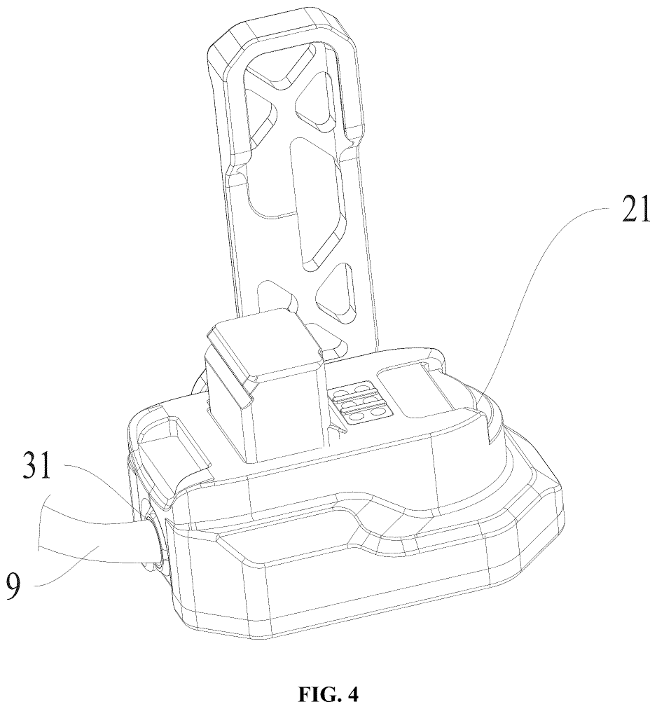

It is noteworthy that the power supply method of the power supply component 3 can be integrated into the stabilizer mounting component 2 and may encompass multiple power supply modes. In the first mode, the power supply component 3 is situated on the handheld component 1 and electrically connected to the stabilizer mounting component 2 to supply power to the stabilizer mounting component 2, thereby enabling the handheld component 1 to be powered. In this embodiment, the stabilizer mounting component 2 may include a connecting base 21 installed on the handheld component 1 and electrically connected to the electrical connecting line 19. The power supply component 3 is electrically connected to the connecting base 21. Referring to FIG. 4, the power supply component 3 includes a power supply interface 31 disposed on the connecting base 21 for connecting to an external power source.

Furthermore, the power supply component 3 also includes a battery mounting bracket 32 for installing a battery as a power source, such as a battery hanging panel, an Anton power tap, a V-mount power tap, etc. The battery hanging panel can accommodate the required battery, while the Anton power tap can provide power by loading an Anton battery, and the V-mount power tap can provide power by loading a V-mount battery. Once the battery mounting bracket 32 loads the battery, the battery can be connected to a power supply base through a power supply line 9. The power supply base is further connected to the electrical connecting line 19 and the stabilizer, thereby powering the handheld component 1 again, which facilitates electrical powering of other structures connected to the handheld component 1. It is worth mentioning that the connecting base 21 may incorporate a circuit board within the handheld component 1, and the electrical connecting line 19 can be welded to the circuit board for electrical connection. Specifically, the electrical connecting line 19 can include multiple wires connected in parallel or in series.

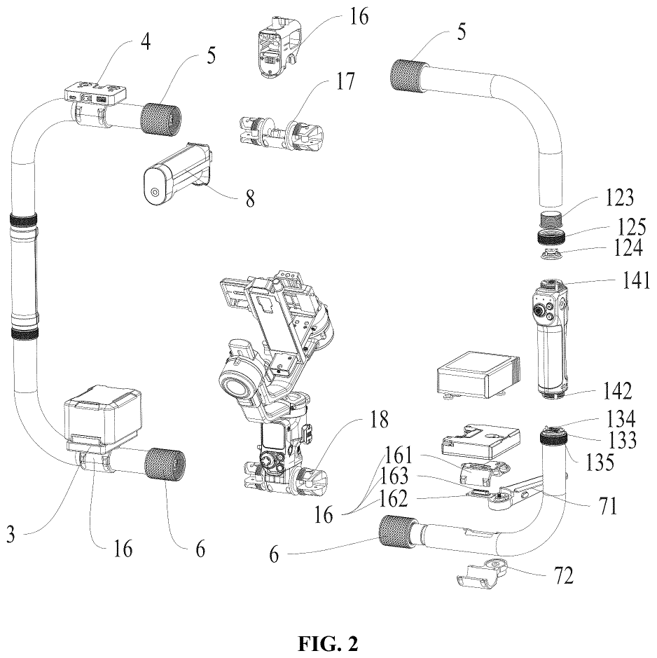

Referring to FIGS. 1-2, the handheld component 1 includes a first ring pipe 12, a second ring pipe 13, a first handle part 14, and a second handle part 15. The first handle part 14 connects at two ends to the first ends of the first ring pipe 12 and the second ring pipe 13, while the second handle part 15 connects at two ends to the second ends of the first ring pipe 12 and the second ring pipe 13. Specifically, the two ends of the first ring pipe 12 are bonded with the first alloy sleeve 123, and screws pass through the first disk 124 and the first threaded connection bayonet 125 to connect to the first alloy sleeve 123. One end of the first disk 124 is connected to the electrical connecting line 19, which passes through the first ring pipe 12 to connect to the upper electrical port 16. A screw passes through the upper electrical port 16 and connects to the corresponding first ring pipe 12 after passing. Similarly, the two ends of the second ring pipe 13 are bonded with the second alloy sleeve 133, and screws at the lower end pass through the second disk 134 and the second threaded connection bayonet 135 to connect to the second alloy sleeve 133. One end of the second disk 134 is connected to the electrical connecting line 19, which passes through the second ring pipe 13 to connect to the middle stabilizer mounting component 2 and the lower electrical port 16. The electrical port 16 includes a mounting piece 161, a circuit board 162, and contact pins 163. The mounting piece 161 is attached to the handheld component 1, the circuit board 162 is disposed inside the handheld component 1, and the contact pins 163 are electrically connected to the circuit board and exposed outside the mounting piece 161 for electrical connection with the power supply component 3. The circuit board 162 is electrically connected to the electrical connecting line 19. Additionally, the electrical port 16 can be electrically connected to the output port 4, which is positioned and connected to the upper electrical port 16 with the pipe clamp. The spring contacts of the output port contact the contacts of the upper electrical port 16 on the pipe body, forming an electrical circuit. The output port 4 is equipped with a series of standard ARRI interfaces, cold shoe interfaces, USB ports, D-tap ports, offering multiple output options and external device interfaces.

Furthermore, the first handle part 14 and the second handle part 15 can be simple handles, dual-focus handles, or stabilizer control handles. Specifically, the simple handle includes a third threaded connection bayonet 141 and a fourth threaded connection bayonet 142 and functions solely as a handle grip. The dual-focus handle, which also includes a third threaded connection bayonet 141 and a fourth threaded connection bayonet 142, is internally equipped with a control terminal and a built-in power drive. Additionally, the dual-focus handle features a handwheel that allows for wireless connection to two motors installed on the camera lens. By turning the handwheel, the dual-focus handle can control the rotational movement of the motors, thereby adjusting the focal length area on the lens for focusing, zooming, and other operations. Similarly, the stabilizer control handle, which also includes a third threaded connection bayonet 141 and a fourth threaded connection bayonet 142, is internally equipped with a control terminal and a built-in power drive. The stabilizer control handle further includes a joystick and a handwheel. The stabilizer control handle wirelessly connects to the stabilizer, and the joystick's swing can control the stabilizer's rotation in two axial directions, thereby adjusting the camera's orientation for capturing shots. The handwheel controls the rotation of the motor connected to the camera lens, allowing for focusing, zooming, and other operations. Moreover, the third threaded connection bayonet 141 can be aligned with the first threaded connection bayonet 125 of the first ring pipe 12 for installation, while the fourth threaded connection bayonet 142 can be aligned with the second threaded connection bayonet 135 of the second ring pipe 13 for installation. By rotating the first threaded connection bayonet 125 of the upper ring pipe and the second threaded connection bayonet 135 of the lower ring pipe, the ring pipe body is connected to the left and right handles, forming a complete closed loop.

Configured as described, when the power supply component 3 is connected to an external battery, it can power the stabilizer mounting component 2, which then powers the handle through an internal wiring setup, among other options. Alternatively, the power supply component 3 can be electrically connected to the electrical connecting line 19 to enable the handheld component 1 to be powered on. For instance, a V-mount battery power supply component 3 or/and an Anton battery power supply component 3 can be electrically connected to the electrical connecting line 19, and then power the stabilizer and handle through internal wiring. Specifically, the power supply component 3 connects to the lower electrical port 16 via electrical contact pins, and the internal circuit board of the lower electrical port 16 can be electrically connected to the electrical connecting line 19 by welding, among other methods. Alternatively, the power supply component 3 can also be a docking handle 8.

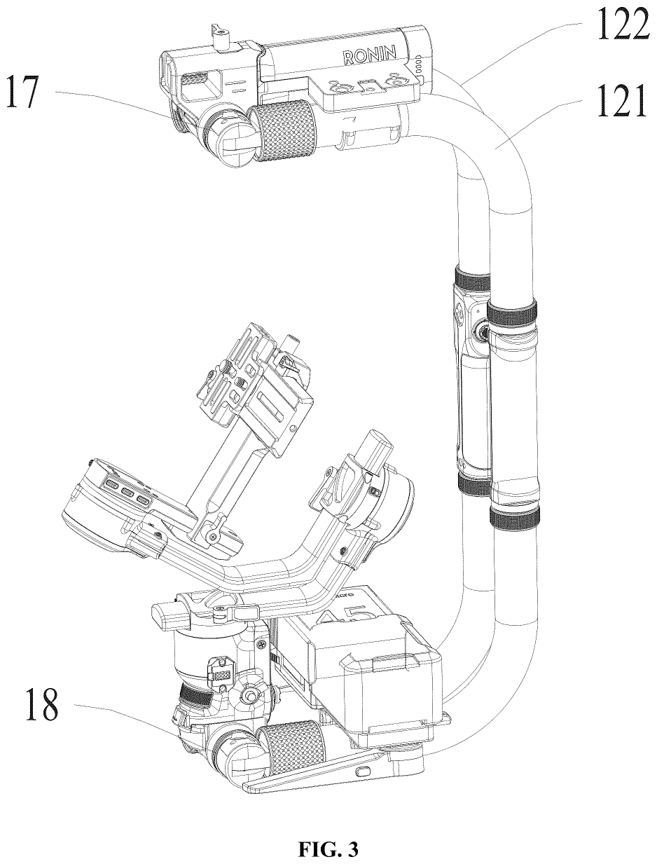

Referring to FIG. 3, in some embodiments, the handheld component 1 includes a first ring pipe 12, a second ring pipe 13, a first handle part 14, and a second handle part 15. The first handle part 14 connects at two ends to the first ends of the first ring pipe 12 and the second ring pipe 13, while the second handle part 15 connects at two ends to the second ends of the first ring pipe 12 and the second ring pipe 13. Specifically, the first ring pipe 12 includes a first pipe 121 and a second pipe 122, and the second ring pipe 13 includes a third pipe 131 and a fourth pipe 132. The first and the second pipes 121 and 122 are movably connected, and similarly, the third and the fourth pipes 131 and 132 are movably connected, allowing the handheld component 1 to be folded. In more detail, the handheld component 1 also includes a first connecting segment 17, a second connecting segment 18, multiple first unlocking rings 5, and multiple second unlocking rings 6. The stabilizer mounting component 2 is mounted on either the first connecting segment 17 or the second connecting segment 18. The two ends of the first connecting segment 17 are connected to the first pipe 121 and the second pipe 122, respectively, via a first pivot, while the two ends of the second connecting segment 18 are connected to the third pipe 131 and the fourth pipe 132, respectively, via a second pivot. Two first unlocking rings 5 can be individually sleeved onto the first pipe 121 and the second pipe 122, and movably connect with the respective ends of the first connecting segment 17. Similarly, two second unlocking rings 6 can be individually sleeved onto the third pipe 131 and the fourth pipe 132, and they movably connect with the respective ends of the second connecting segment 18. When the first unlocking rings 5 and the second unlocking rings 6 are rotated to disconnect from the first connecting segment 17 and the second connecting segment 18, respectively, the first ring pipe 12 and the second ring pipe 13 can rotate relative to these connecting segments to fold. Taking the first connecting segment 17 as an example (the principle for the second connecting segment 18 is equivalent), the two ends of the first connecting segment 17 feature external threads, and the first unlocking rings 5 have internal threads. When the first unlocking rings 5 are loosened and moved away from the first connecting segment 17, the first ring pipe 12 and the second ring pipe 13 can fold relative to the first connecting segment 17. When users need to store the device for portability, they can rotate the first unlocking rings 5 on the upper and lower parts of the ring-shaped handheld component to move the first unlocking rings 5 towards the first ring pipe 12 and the second ring pipe 13, respectively. Then, users can use both hands to pull the first ring pipe 12 and the second ring pipe 13, so that both the first ring pipe 12 and the second ring pipe 13 can move relative to the first connecting segment 17 for folding. When in use, pull apart the first ring pipe 12 and the second ring pipe 13 for alignment, and then tighten the first unlocking rings 5 onto the first connecting segment 17 for threaded connection, transitioning to the ready-for-use state.

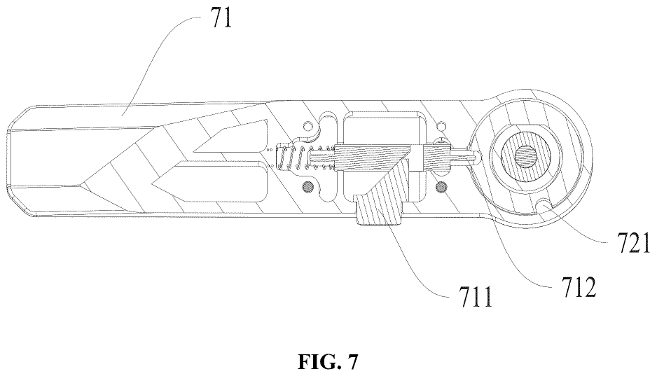

On the other hand, referring to FIG. 7, the handheld component 1 is equipped with a tripod 7, which includes a connecting part 72 and a foot support part 71. The connecting part 72 is detachable from the handheld component 1, and the corresponding foot support part 71 is movably connected to the connecting part 72, allowing for rotating relative to the connecting part 72. When the handheld component 1 is folded, the foot support part 71 can also fold relative to the connecting part 72 for storage.

Specifically, the foot support part 71 and the connecting part 72 are hinged together, and multiple limiting holes 721 are provided on the periphery of the connecting part 72. The foot support part 71 is equipped with a button 711 and a limiting part 712. The limiting part 712 is elastically mounted on the foot support part 71, specifically via a spring, and cooperates with the inclined surface of the button 711. When the button 711 is pressed, the limiting part 712 can be withdrawn from the limiting hole 721 due to the pressure from the inclined surface, allowing the foot support part 71 to rotate for opening or folding. Two of the limiting holes 721 correspond to the positions of the foot support part 71 when it is open and folded, respectively.

It is emphasized that the aforementioned embodiments serve as preferred illustrations and do not constitute limitations on the scope of the patent claims presented herein. Any structural modifications that are deemed equivalent, based on the disclosure and drawings of this application, or their direct/indirect application in related technical domains, fall within the ambit of patent protection afforded to this application, in line with its underlying concept.

What is claimed is:

1. An auxiliary shooting structure, comprising:
a handheld component, comprising an accommodation cavity configured to house an electrical connecting line;
a stabilizer mounting component is configured to mount on the handheld component and electrically connect to the electrical connecting line for mounting a stabilizer;
a power supply component is provided on at least one of the handheld component or the stabilizer mounting component; and
wherein the power supply component is configured to electrically connect to at least one the stabilizer mounting component or the electrical connecting line.

2. The auxiliary shooting structure according to claim 1, wherein the power supply component is provided on the stabilizer mounting component or the stabilizer to supply power to the stabilizer mounting component, enabling the handheld component to be powered.

3. The auxiliary shooting structure according to claim 2, wherein the stabilizer mounting component comprises a connecting base installed on the handheld component and electrically connected to the electrical connecting line; and
wherein the power supply component comprises a power supply interface provided on the connecting base.

4. The auxiliary shooting structure according to claim 3, wherein the power supply component comprises a battery mounting bracket on the handheld component; and wherein the battery mounting bracket is configured to mount a battery, and a power supply line can be inserted into the power supply interface to provide power to the connecting base.

5. The auxiliary shooting structure according to claim 1, wherein the power supply component is electrically connected to the electrical connecting line, enabling the handheld component to be powered.

6. The auxiliary shooting structure according to claim 5, wherein the power supply component comprises a battery mounting bracket, and the battery mounting bracket is configured to mount a battery, and the battery mounting bracket is electrically connected to the electrical connecting line.

7. The auxiliary shooting structure according to claim 5, wherein the power supply component comprises a V-mount battery power supply component or an Anton battery power supply component.

8. The auxiliary shooting structure according to claim 5, wherein the power supply component comprises a docking handle.

9. The auxiliary shooting structure according to claim 6, further comprising an electrical port on the handheld component;
wherein the electrical port comprises a mounting member, a circuit board, and a contact pin;
wherein the mounting member is mounted to the handheld component, the circuit board is housed within the handheld component, and the contact pin is electrically connected to the circuit board and being exposed outside the mounting member to be electrically connect to the battery mounting bracket; and
wherein the circuit board is electrically connected to the electrical connecting line.

10. The auxiliary shooting structure according to claim 1, wherein the handheld component comprises a first ring pipe, a second ring pipe, a first handle part, and a second handle part; and
wherein the first handle part is configured to connect at two ends to a first end of the first ring pipe and a first end of the second ring pipe, respectively, and
wherein the second handle part is configured to connect at two ends to a second end of the first ring pipe and a second end of the second ring pipe, respectively.

11. The auxiliary shooting structure according to claim 10, wherein the first ring pipe comprises a first pipe and a second pipe, and the second ring pipe comprises a third pipe and a fourth pipe; and
wherein the first pipe and the second pipe are movably connected, and the third pipe and the fourth pipe are movably connected, enabling the handheld component to be folded.

12. The auxiliary shooting structure according to claim 11, wherein handheld component comprises a first connecting segment, a second connecting segment, a plurality of first unlocking rings, and a plurality of second unlocking rings;
wherein the stabilizer mounting component is mounted on either the first connecting segment or the second connecting segment;
wherein two ends of the first connecting segment are connected to the first pipe and the second pipe via a first pivot, and two ends of the second connecting segment are connected to the third pipe and the fourth pipe via a second pivot;
wherein two first unlocking rings of the plurality of first unlocking rings are capable of being mounted on the first pipe and the second pipe, respectively, and are movably connected to two ends of the first connecting segment;
wherein two second unlocking rings of the plurality of second unlocking rings being mounted on the third pipe and the fourth pipe, respectively, and are movably connected to two ends of the second connecting segment; and
wherein the first ring pipe and the second ring pipe are capable of rotating relative to the first connecting segment and the second connecting segments for folding when the plurality of first unlocking rings and the plurality of second unlocking rings are rotated to disconnect from the first connecting segment and the second connecting segment, respectively.
